(19) United States
(12) Patent Application Publication
(10) Pub. No.: US 2014/0232506 A1
(43) Pub. Date: Aug. 21, 2014

(54) BUILDING-BLOCK-COMBINED-TYPE HIGH POWER TRANSFORMER

(71) Applicant: Chang-Yu Pan, New Taipei City (TW)

(72) Inventor: Chang-Yu Pan, New Taipei City (TW)

(21) Appl. No.: 14/264,487

(22) Filed: Apr. 29, 2014

Related U.S. Application Data
(63) Continuation-in-part of application No. 13/344,561, filed on Jan. 5, 2012.

(51) Int. Cl. H01F 27/24

(52) U.S. Cl. CPC H01F 27/24
USPC 336/212

(57) ABSTRACT

A building-block-combined-type high power transformer includes a first iron core body , a second iron core body , a plurality of plate bodies, and a plurality of isolating bodies. The first iron core body and the second iron core body have a first side wing part and a second side wing part respectively at both sides thereof. Both of the first side wing part and the second side wing part being a circular shape at both ends respectively thereof have a first open channel and a second open channel formed between thereof where the second iron core body is in contact with the first iron core body. Each of the plate bodies being positioned in both the first open channel and second open channel has an open hole, for containing both of the first side wing part, and the second side wing part, and a guided channel that is positioned on the second side of the open hole. The isolating bodies being annular in shape and being positioned in between the first plate bodies and the second plate bodies have a through hole corresponding to the open hole for containing the first side wing part and the second side wing part.

### BACKGROUND OF THE INVENTION

1. Field of the Invention

The invention relates to a building-block-combined-type high power transformer, and more particularly, to a building-block-combined-type high power transformer employing a principle of building block combination to be utilized in the high power (3,000 Watts and above).

2. Description of the Prior Art

Since the high technology in the field of microelectronics advances with giant stride, the relevant manufacturing process changes with each passing day, and the electronic products, having deepened into each family and all walks of life, become indispensable part in modern life.

Traditionally, the transformer for driving the light tube of the back-light-module in the LCD (Liquid Crystal Display) has a coil seat having a primary coil zone and a secondary coil zone and a plurality of computer terminals for connecting the electrically conductive wire to the winding and for brazing to the circuit board. As the technology keeps on making progress and under the demand of high luminance for the LCD, some manufacturers have already increased the number of light tube in the back-light-module in the LCD, as a result, the number of the transformer is also increased. Consequently, the size of the LCD is getting larger, and its weight is getting heavier too. Some manufacturers utilizes a single transformer to drive a number of light tubes, in this case, the power of the transformer needs to be increased to accommodate the high power output. In this way, using a single transformer to drive a number of light tubes, since both the primary coil and the secondary coil are wound around the same winding frame making the room of the winding zone of the primary coil very limited. Therefore, the number of the winding coil on the primary coil zone and the secondary coil zone need to be increased, as a result, the thickness and the volume of the transformer will be increased accordingly.

Moreover, as the loading power increases, significant problem of temperature rise in the primary coil will be generated which will result in over-heat phenomenon. An increase in the diameter of the coil in the primary coil may resolve the problem of temperature rise, but it will further increase the thickness of the transformer. What is more, in above-mentioned transformers of the prior art, if the problems of “safety regulation and isolation” of the “primary coil and the secondary coil” wound around the same winding frame is considered, the extent of difficulty of voltage durability on the high voltage winding is relatively higher making the manufacturing and cost of the parts of the transformer relatively unfavorable. Moreover, high power transformer needs to make large scale iron core body which requires employing large scale casting machine to manufacture making the manufacturing cost very high.

Therefore, just how to resolve the above-mentioned problems has become an urgent issue to seek for an improving program in the industry.

### SUMMARY OF THE INVENTION

In light of the above-mentioned disadvantages of the prior art, the invention provides a building-block-combined-type high power transformer that is capable of overcoming the shortcomings of the prior art, satisfying the requirements of the industry, as well as improving the competitiveness in the market. It aims to ameliorate at least some of the disadvantages of the prior art or to provide a useful alternative.

The primary objective of the invention is to provide a building-block-combined-type high power transformer by making use of forming a large scale iron core body structure by building-block combination through press-working a single small type of iron core body structure, thereby to achieve the efficacy of lowering the cost of making a large scale iron core body structure.

The secondary objective of the invention is to provide a building-block-combined-type high power transformer by making use of a plurality of stacking up thin copper sheets and disposing the pole leads in different positions to replace the coils twisted by enamel covered wire to achieve the efficacies of saving space and lowering the loss due to eddy current.

The third objective of the invention is to provide a building-block-combined-type high power transformer by making use of a plurality of stacking up thin copper sheets to achieve the efficacy of having the capability of being utilized in the high power (3,000 Watts and above)

The fourth objective of the invention is to provide a building-block-combined-type high power transformer by making use of a plurality of stacking up thin copper sheets to achieve the efficacy of having the capability of saving more time in assembly and manufacturing process.

The fifth objective of the invention is to provide a building-block-combined-type high power transformer by making use of forming a large scale iron core body structure by building-block combination such that the first side wing part (11a) and the second side wing part (11b) of the central portion are arranged to form substantially a square opening to achieve the efficacy of fast heat-dissipation.

To achieve the above-mentioned objective, a building-block combined-type high power transformer includes a first iron core body (1a), a second iron core body (1b), a plurality of plate bodies (2), and a plurality of isolating bodies (3). The first iron core body (1a) and the second iron core body (1b) have a first side wing part (11a) and a second side wing part (11b) respectively at both sides thereof. Both of the first side wing part (11a) and the second side wing part (11b) being a circular shape at both ends respectively thereof have a first open channel (12a) and a second open channel (12b) formed between thereof where the second iron core body (1b) is in contact with the first iron core body (1a). Each of the plate bodies (2) being positioned in both the first open channel (12a) and second open channel (12b) has an open hole (21) for containing both of the first side wing part (11a) and the second side wing part (11b), and a guided channel (22) that is positioned on the second side (26) of the open hole (21). The isolating bodies (3) being annular in shape and being positioned in between the first plate bodies (2a) and the second plate bodies (2b) have a through hole (31) corresponding to the open hole (21) for containing the first side wing part (11a) and the second side wing part (11b).

The accomplishment of this and other objectives of the invention will become apparent from the following description and its accompanying drawings of which:

### BRIEF DESCRIPTION OF THE DRAWINGS

FIG. 1 is a top isometric view of the iron core body of the building-block-combined-type high power transformer of the first preferred embodiment of the invention.

FIG. 2A is an exploded view of the building-block-combined-type high power transformer of the first preferred embodiment of the invention.

FIG. 2B is an isometric view of the assembled structure of the building-block-combined-type high power transformer of the first preferred embodiment of the invention.

FIG. 3A is an exploded view of the building-block-combined-type high power transformer of the second preferred embodiment of the invention.

FIG. 3B is an isometric view of the assembled structure of the building-block-combined-type high power transformer of the second preferred embodiment of the invention.

### DETAILED DESCRIPTION OF THE PREFERRED EMBODIMENT

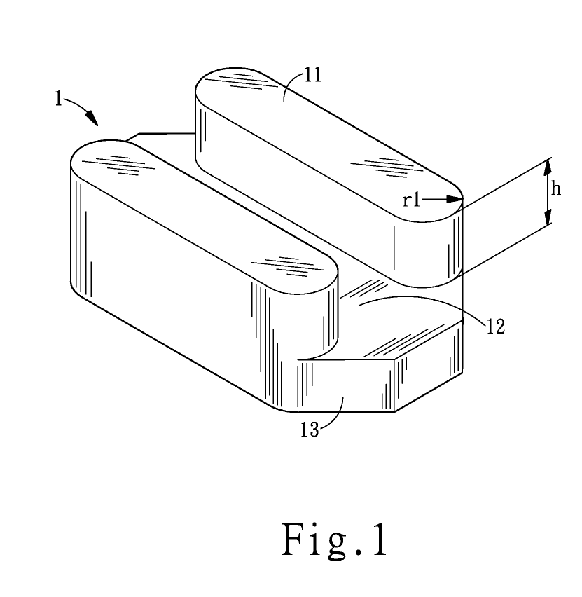

FIG. 1 is a top isometric view of the iron core body of the building-block-combined-type high power transformer of the first preferred embodiment of the invention. As shown in FIG. 1, the iron core body (1) of the building-block-combined-type high power transformer of the invention is polygon in shape. In a first preferred embodiment of the invention, the iron core body (1) being made of electrically conductive material is an octagon in shape. The iron core body (1) has a side wing part (11) on both sides respectively thereof where both ends of the side wing parts (11) are circular in shape with radius of curvature “r1” and radius of curvature “r2”. Moreover, an open channel (12) is formed between the two side wing parts (11) with a height “h” between the bottom of the open channel (12) and the top of the side wing part (11). What is more, the iron core body (1) has at least a slant channel (13) on both ends thereof.

Since the building-block-combined-type high power transformer is formed by the use of a plurality of the above-mentioned iron core bodies (1) to arrange and combine in accordance with different number, a majority of the following elements are the same as the above-mentioned embodiment. In order to facilitate the proceeding of this patent specification, the following iron core bodies (1) are all the same as the ones in the above-mentioned embodiment except that they are differentiated by, for example, first iron core body (1a) and second iron core body (1b) by adding alphabet, e.g. (a), (b) to the numeral (1) to become, e.g. (1a), (1b).

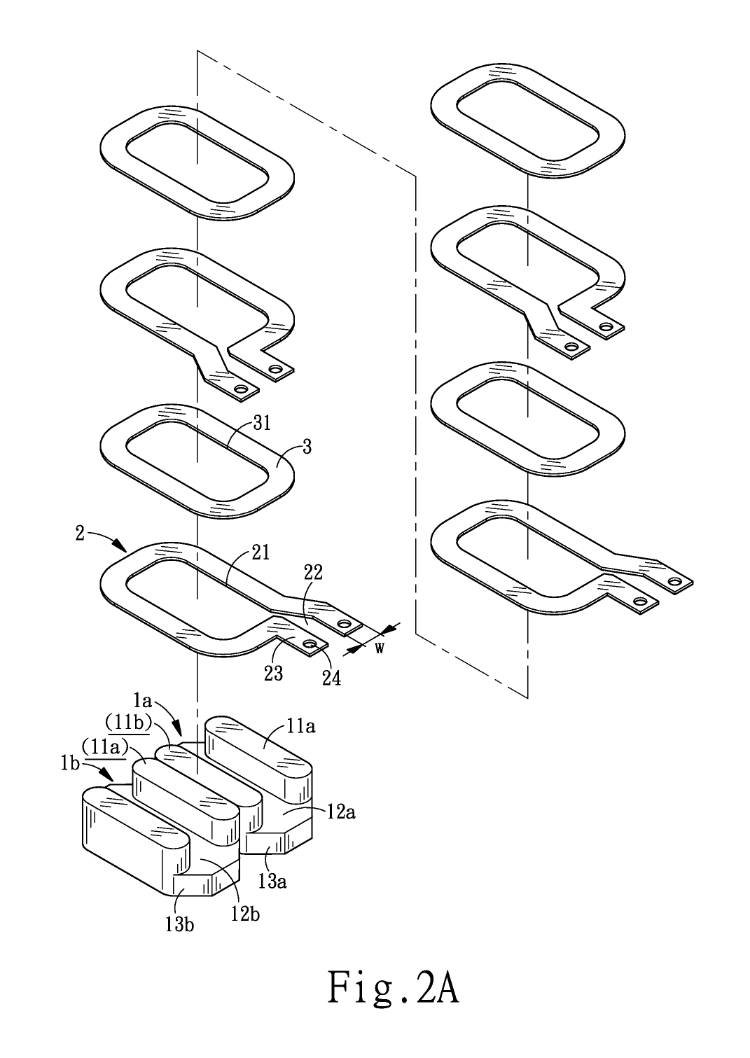

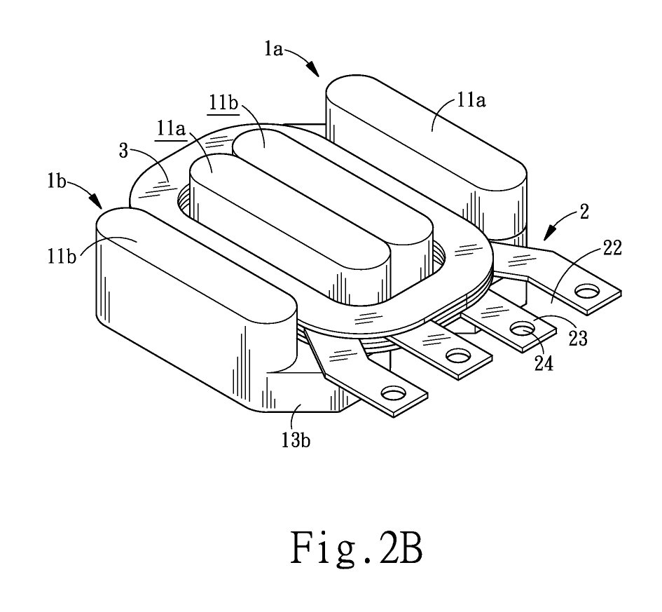

FIG. 2A is an exploded view of the building-block-combined-type high power transformer of the first preferred embodiment of the invention, while FIG. 2B is an isometric view of the assembled structure of the building-block-combined-type high power transformer of the first preferred embodiment of the invention. As shown in FIG. 2A, and FIG. 2B, the building-block-combined-type high power transformer of the first embodiment of the invention being consisted of two iron core bodies (1) includes a first iron core body (1a), a second iron core body (1b), a plurality of plate bodies (2a), a plurality of plate bodies (2b), and a plurality of insulating bodies (3). The first iron core body (1a) being polygon in shape has a first side wing part (11a) on both sides respectively thereof where both ends of the first side wing part (11a) are circular in shape with a first radius of curvature “r1”. Moreover, a first open channel (12a) is formed between the two first side wing parts (11a). Similarly, the second iron core body (1b) being polygon in shape has a second side wing part (11b) on both sides respectively thereof where both ends of the second side wing part (11b) are circular in shape with a second radius of curvature “r2”. What is more, a second open channel (12b) is formed between the two second side wing parts (11b). The second iron core body (1b) is in contact side-by-side with the first iron core body (1a) making the second side wing part (11b) in contact side-by-side with first side wing part (11a).

In a preferred embodiment of the invention, each of the plate bodies (2a), being a Tin-plated copper sheet and being integrally formed, possesses an open hole (21) for containing the first side wing part (11a) and second side wing part (11b), a guided channel (22), and two pole lead (23). The open hole (21) of the first plate body (2a) has four sides, i.e. a first side (25), a second side (26), a third side (27), and a fourth side (28). The guided channel (22) being positioned on the second side (26) of the open hole (21) and corresponding to the open channel (12) has a pole lead (23) on each side thereof making the two pole leads (23) furnished on each side of the guided channel (22), and the pole leads (23) are offset toward the fourth side (28). Plate bodies (2b) are formed by flipping over the plate bodies (2a) with a 180-degree angle with respect to a central axis x-x. Moreover, the pole lead (23) having a circular hole (24) has a width “w” that is capable of being adjusted to accommodate the requirements of different electrical resistance needed for providing the connection for various circuit layouts.

As shown in FIG. 2A, in a preferred embodiment of the invention, the plurality of plate bodies (2a) and a plurality of plate bodies (2b) as well as the insulating body (3) are alternately stacked up on both the first side wing part (11a) and the second side wing part (11b) with the insulating body (3) inserting in between the first plate body (2a) and second plate body (2b). The insulating body (3) being a structure in annular shape has a through hole (31) for containing the first side wing part (11a) and the second side wing part (11b). Moreover, the insulating body (3) being positioned in between the first plate body (2a) and second plate body (2b) is made of electrically non-conductive material and is capable of preventing the first plate body (2a) and second plate body (2b) from forming electrical connection and becoming short circuit. Since the plurality of plate bodies (2a) and plate bodies (2b) are alternately stacked up on the top of both the first side wing part (11a) and second side wing part (11b) making the first side wing part (11a) and the second side wing part (11b) correspond to at least a guided channel (22) respectively for providing the connection to the pole leads (23) of different circuit layouts, the invention having the plurality of plate bodies (2a) alternately stack up with the plurality of plate bodies (2b) to replace the coil twisted by enamel wires is capable of achieving the efficacies of saving space and lowering the loss due to the eddy current such that the invention is capable of being utilized in the high power (3,000 Watts and above).

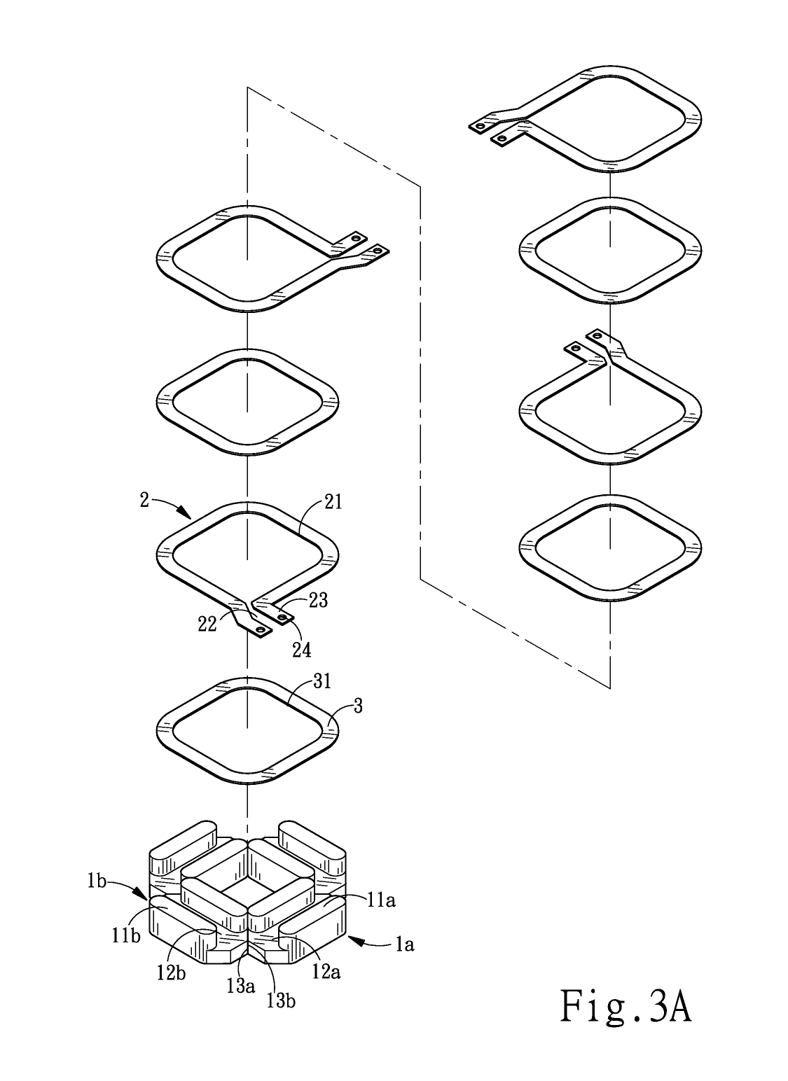

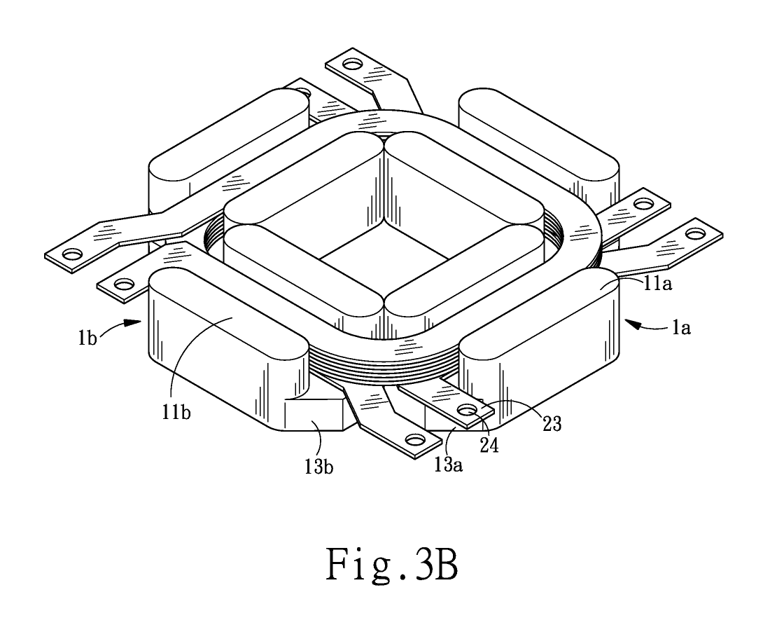

FIG. 3A is an exploded view of the building-block-combined-type high power transformer of the second preferred embodiment of the invention while FIG. 3B is an isometric view of the assembled structure of the building-block-combined-type high power transformer of the second preferred embodiment of the invention. As shown in FIG. 3A, and FIG. 3B, the building-block-combined-type high power transformer of the invention being consisted of four of the above-mentioned iron core bodies (1) includes two first iron core bodies (1a), two second iron core bodies (1b), and a plurality of isolating bodies (3). In a preferred embodiment of the invention, the two first iron core bodies (1a) and the two second iron core bodies (1b) are arranged in opposite positions respectively making a second slant channel (13b) in contact with a first slant channel (13a). Accordingly, the first side wing part (11a) and the second side wing part (11b) of the central portion are arranged to form substantially a square opening to achieve the efficacy of fast heat-dissipation. In this way, the open hole (21) of each of the plate bodies (2) is capable of containing the first side wing parts (11a) and the second side wing parts (11b) that arranged in square opening. The plate bodies (2) are alternately stacked up with the isolating bodies (3) having each of the plate bodies (2) successively rotate a 90-degree angle in counter-clockwise direction with respect to a central y-y axis such that there is at least a guided channel (22) appeared at each of the contact location between the second slant channel (13b) and the first slant channel (13a) to provide pole leads (23) for the connections of various circuit layouts. Accordingly, the through hole (31) of each the isolating bodies (3) is exactly containing the first side wing part (11a) and the second side wing part (11b) with the isolating body (3) positions exactly in between the each of the two plate bodies (2). The isolating body (3) being made of electrically non-conductive material is capable of preventing the two plate bodies (2) from forming electrical connection and from becoming short circuit. Therefore, the invention having the plurality of plate bodies (2) alternately stack up each other to replace the coil twisted by enamel wires is capable of achieving the efficacies of saving space and lowering the loss due to the eddy current such that the invention is capable of being utilized in the high power (3,000 Watts and above).

In a conclusion, the building-block-combined-type high power transformer of the invention is capable of substantially resolving the demerits of the prior art, satisfying the requirements and improving the competitiveness of the industry in the field, thereby, is possessing the patentability of having the non-obviousness subject matter and the applicability in the industry in the field.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A building-block-combined-type high power transformer, comprising:
a first iron core body being a polygon in shape and having a first side wing part on both sides respectively thereof where both ends of the first side wing part are circular in shape with a first radius of curvature “r1”, and a first open channel is formed between the two first side wing part;
a second iron core body being a polygon in shape and having a second side wing part on both sides respectively thereof where both ends of the side wing parts are circular in shape with a second radius of curvature “r2”, and a second open channel is formed between the two second side wing part, also the second iron core body is in contact side-by-side with the first iron core body;
a plurality of the first plate bodies and the second plate bodies each having an open hole and a guided channel and both of them being positioned in both of the first open channel and the second open channel where the open hole having a first side, a second side, a third side, and a fourth side contains the first side wing part and the second side wing part; moreover, the guided channel being positioned on the second side of the open hole has a pole lead on both sides of thereof; what is more, the plate bodies are formed by flipping over the plate bodies with a 180-degree angle with respect to a central axis x-x; and
a plurality of isolating bodies being annular in shape and being positioned in between the first plate bodies and the second plate bodies have a through hole corresponding to the open hole for containing the first side wing part and the second side wing part , whereby, the building-block-combined-type high power transformer having the plurality of first plate bodies alternately stack up with the plurality of second plate bodies to position on the first side wing part and the second side wing part making the first open channel and the second open channel corresponding respectively to at least a guided channel to provide the connection of the pole lead for various circuit layouts.

2. The building-block-combined-type high power transformer as claimed in claim 1, wherein the first plate bodies and the second plate bodies are tin-plated copper sheets.

3. The building-block-combined-type high power transformer as claimed in claim 1, wherein the first iron core body is made of electrically conductive material by press working.

4. The building-block-combined-type high power transformer as claimed in claim 1, wherein the second iron core body is made of electrically conductive material by press working.

5. The building-block-combined-type high power transformer as claimed in claim 1, wherein the second side wing part is in contact with one of the first side wing parts.

6. The building-block-combined-type high power transformer as claimed in claim 1, wherein the plurality of first plate bodies and the second plate bodies are alternately stacked up in the first open channel and second open channel making the first open channel and the second open channel correspond at least a guided channel.

7. The building-block-combined-type high power transformer as claimed in claim 5, wherein the plurality of first plate bodies and the second plate bodies are alternately stacked up in the first open channel and second open channel making the first open channel and the second open channel correspond at least a guided channel.

8. The building-block-combined-type high power transformer as claimed in claim 1, wherein both end of the first iron core body has at least a first slant channel and both ends of the second iron core body has at least a second slant channel.

9. The building-block-combined-type high power transformer as claimed in claim 7, wherein the second slant channel is in contact with the second slant channel.

10. The building-block-combined-type high power transformer as claimed in claim 8, wherein the plurality of first plate bodies and the plurality of second plate bodies are alternately stacked up in the first open channel and second open channel making the location where the second slant channel in contact with the first slant channel correspond at least a guided channel.

11. The building-block-combined-type high power transformer as claimed in claim 9, wherein the plurality of first plate bodies and the plurality of second plate bodies are alternately stacked up in the first open channel and second open channel making the location where the second slant channel in contact with the first slant channel correspond at least a guided channel.

12. The building-block-combined-type high power transformer as claimed in claim 1, wherein the insulating body is made of electrically non-conductive material.
